(19) United States
(12) Patent Application Publication
(10) Pub. No.: US 2009/0108662 A1
(43) Pub. Date: Apr. 30, 2009

(54) Seat back with integrated seat belt

(75) Inventors: Burckhard Becker, Sollngen (DE); Stefen Pietas, Sollngen (DE); Robert Houston, Lelchllngen (DE); Jozef Potecln, Sollngen (DE)

Correspondence Address: John Lezdey, Suite 118, 2401 West Bay Drive, Largo, FL, 33770, US

(73) Assignee: C. Rob. Hammerstein GmbH & Co. KG

(21) Appl. No.: 12/287,332

(22) Filed: Oct. 8, 2008

(30) Foreign Application Priority Data
Oct. 25, 2007 (DE) 10 2007 051 424 9

(51) Int. Cl. B60N 2/68; B60N 2/64; A47C 7/40

(52) U.S. Cl. 297/452.2; 297/452.18

(57) ABSTRACT

The seat back of a motor vehicle seat with an integrated seat belt has a frame having two side parts and an upper base connecting the side parts and an upper belt point provided in proximity to the first upper corner. It further contains an L-shaped supporting body. The supporting body has a long leg connected to the frame in proximity to a first upper corner, of a length substantially equalling the length of the neighbouring side part and extending at an acute angle with respect to the neighbouring side part. A short leg is connected to the upper base, and a lower carrier piece connects a lower end of the long leg to the neighbouring side part so that the neighbouring side part, the long leg and the carrier piece form an acute-angled triangle.

The invention relates to a structure of a seat back of a motor vehicle seat with integrated seat belt, said seat back comprising a frame having two side parts and one upper base connecting said side parts and one upper belt point provided in proximity to the first upper corner.

Such type seat back is known from U.S. Pat. No. 5,988,759 or from DE 197 17 666 A1. The previously known structure of a seat back consists of a very solid frame that is a piece of a tube curved in a U shape. A carrier arm, which projects upward substantially in the z direction, is attached to the frame in the top portion thereof, in a first corner, when viewed in the x direction the left top corner. At its free end, there is a belt point. There, a seat belt is guided, deflected or otherwise retained. In the event of an accident, considerable belt forces occur at this belt point.

The disadvantage of this structure of the seat back is that the frame is very solid; accordingly it has a considerable weight, can only be worked at high expense and is extremely rigid, meaning that it is not designed to absorb energy.

A double seat arrangement for a motor vehicle is known from DE 103 11 869 A1, the seat back being in this case as well a curved tube frame. No provisions have been taken to integrate a belt though. In DE 103 41 745 A1, an integrated seat is shown, the structure of the seat back being of a quite complex and complicated construction.

In view thereof, it is the object of the invention to develop a simpler tube frame as it is known for example from the mentioned document DE 103 11 869 and which is of a significantly lighter construction than the frame mentioned above, so that it is suited for integrating a belt. As few as possible components should be utilized and the construction it aims at achieving should be simple and light-weighted.

This object is achieved by a structure of a seat back that comprises, in addition to the above mentioned features, an L-shaped supporting body 30, said supporting body 30 comprising one long leg that is connected to the frame in a first top corner, of substantially the length of the neighbouring side part and inclined at an acute angle with respect to this neighbouring side part, and one short leg that is connected to the base and comprises a lower carrier piece that connects a lower end of the long leg to the neighbouring side part so that the neighbouring side part, the long leg and the carrier piece form an acute-angled triangle.

In particular through the quite simple supporting body component part, which is also referred to as a cane, the side part that must substantially take the forces of the shoulder belt of a seat belt is sufficiently rigidified for integration of the belt. For this supporting body, a tube material can be used, as it is also used for the frame. The supporting body is not very thick; it is located on the side, beside the back of a passenger and before the associated side part anyway.

The lower end of the supporting body is connected to the frame via the carrier piece. An acute-angled triangle is formed as a result thereof. This triangle substantially lies in the x-z plane.

The supporting body has a long leg that is substantially located in the x direction before the neighbouring side part, and a short leg, that is located before the upper base, directly in the x direction. This short leg extends in the y direction. It is approximately located on the same height as the base. It has a length that is considerably shorter than the length of the base and that is for example only ⅓ to ⅛ of the base length. Preferably, the short leg only extends close to a carrier body for a headrest bar.

Preferably, one carrier arm projects upward at the first upper corner and forms the upper belt point in its upper region, preferably at its upper free end. As a result, the upper belt point is located a sufficient distance apart above the top edge of the seat and, as a result thereof, also above the shoulder of a passenger. A belt point is understood to refer to a guide part for the shoulder belt of a seat belt. In the belt point, the shoulder belt is deflected before it runs downward into a belt retractor or it is directly received by a belt retractor. Other implementations are possible. What matter however is that the tensile forces of the shoulder belt are introduced into the seat itself.

The frame preferably is a tube frame, said frame being more specifically a piece of tube that has been bent. The frame can be U-shaped; but it may also be in the shape of an O. In the latter case, the frame also has a lower base. The ends of the piece of tube forming the frame are located in a lower corner and on the same seat side as the supporting body. A connecting piece is preferably provided for connecting the two free ends of the piece of tube together.

Preferably, cross beams are interposed between the neighbouring side part and the long leg, a zigzag shape of this bracing being more specifically provided. As a result, the acute-angled triangle is given increased strength. The stiffening occurs according to the Maxwell diagram and is adapted to the respective need.

The motor vehicle seat is preferably configured in the form of a multiple seat, e.g., a double or triple seat. At least one seat back is configured according to the teaching of claim 1. The seat back next to it can be of a simpler implementation, the side part that is not adjacent can be omitted for example, but it may also be implemented just like the seat back as set forth in claim 1.

Other features and advantages will become more apparent upon reviewing the appended claims and the following non restrictive description of embodiments of the invention, given by way of example only with reference to the drawing. In said drawing:

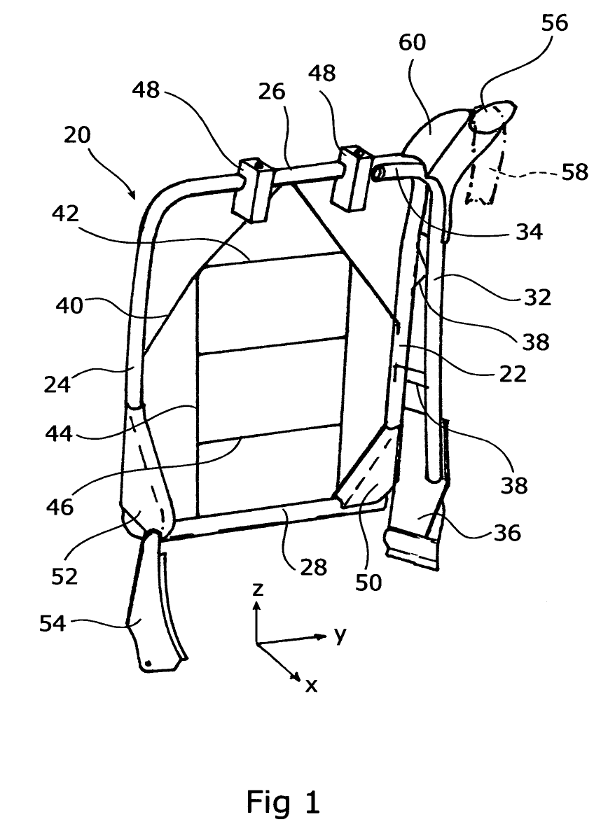

FIG. 1: is a perspective illustration of the structure of a seat back for a motor vehicle seat according to the invention and

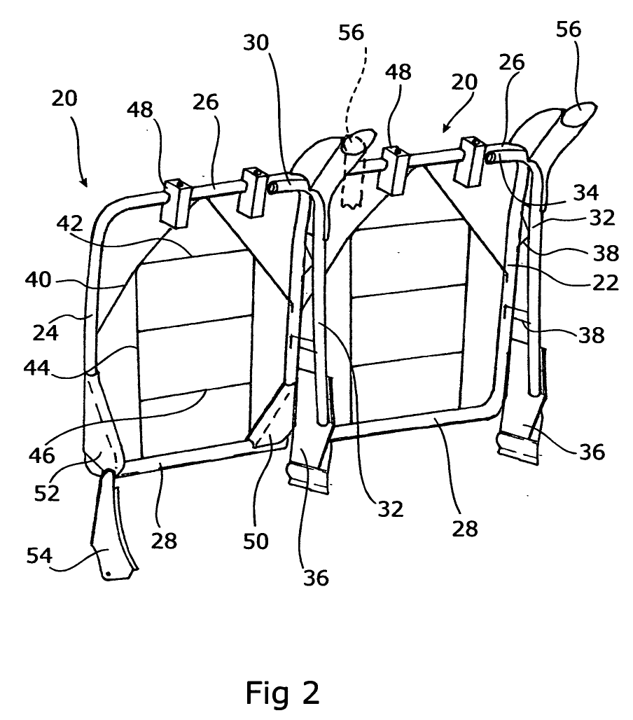

FIG. 2: shows two associated seat backs of a double seat bench in a view like FIG. 1.

In the two Figs., only the structure of a seat back or of two seat backs is shown, the other parts of the seat back, in particular the spring system, the padding, the covering and other component parts, also a belt retractor, a seat back hinge and so on are not shown.

The structure of the seat back of a motor vehicle seat has an O-shaped frame 20 comprising a left side part 22, a right side part 24, an upper base 26 and a lower base 28. The frame 20 is made by bending a piece of tube. A tube is used which has an outer diameter of at least 20 mm and a wall thickness of at least 1.0 mm, e.g., 25 mm diameter and 1.5 mm wall thickness. Solid stock such as aluminium rolled profiles can be utilized. The direction in the x direction is referred to as left and right.

An L-shaped supporting body 30 is connected to this frame 20. This supporting body is also made by bending a piece of tube. It has one long leg 32 and one short leg 34. The supporting body 30 is located before the frame 20 in the x direction. The short leg 34 contacts the upper base 26 to which it is solidly connected. It extends parallel to this upper base 26. It extends over a portion of the length of the upper base 26, for example over 15%.

The supporting body 30 has a curve between its two legs 32, 34, this curve having a radius a curvature in a left upper corner and in a right corner of the frame 20 also has.

The long leg 32 extends (when viewed in the y direction) substantially parallel to the left side part 22, more precisely however at an acute angle thereto. The left side part 22 will be also referred herein after as the neighbouring side part since it is neighbouring the supporting body 30, in contrast to the other side part 24. Between the neighbouring side part 22 and the long leg 32 an acute angle of 5 through 20°, preferably of about 8°, is formed. The long leg 32 has approximately the same length as the neighbouring side part 22.

In their lower regions, the neighbouring side part 22 and the long leg 32 are joined together via a lower carrier piece 36. This connection extends over at least 10%, preferably over at least 20%, of the overall length of the neighbouring side part 22 and also of the long leg 32, so that high strength is generally achieved. As shown in the Figs., the lower carrier piece 36 substantially is a sheet steel blank and extends downward as a continuation. In the lower extension part, the structure of the seat back can be fastened, for example to an under-frame of the seat, to seat side parts or to an arm of a seat back hinge mountings.

Generally, the neighbouring side part 22, the long leg 32 and the lower carrier piece 36 form an acute-angled triangle, this triangle extending substantially in the x-z planes. Between the left side part 22 and the long leg 32 there are disposed cross beams 38; they stiffen the triangle. They are provided according to need. There is shown a zigzag shape (at the top) and cross beams 38 which extend substantially transverse to the frame 20 (at the bottom).

The frame 20 itself is also stiffened. In its upper part, there are two oblique struts 40 that are inclined with respect to each other so as to form a V shape. Approximately in the center of their overall length, each of said oblique struts 40 is connected to an upper Y strut 46 extending in the y direction and to a respective longitudinal strut 44. The two longitudinal struts 44 extend continuously downward to the lower base 28 where they are fastened. Therein between there is located a central Y strut and a lower Y strut 46.

At the upper base 26 there are provided two carrier bodies 48 for receiving bars (not shown) of a headrest that has not been illustrated herein.

The two free ends of the piece of tube, which form the frame 22, are located in immediate proximity to the lower carrier piece 36. They are joined together by an approximately triangular connecting piece 50.

In the right lower corner, a reception part 52, which is also approximately triangular, is connected to the lower portion of the right side part 24. A mountings arm 54 is fastened thereon. Said mountings arm also serves for fastening the seat back, as well as the lower region of the supporting body 30, as described above.

In the left upper corner, there is provided an upper belt point 56 through which runs a shoulder belt 58 shown in a dashed line. The belt point 56 is carried by a carrier arm 60 that is connected to the curved region of the left upper corner and of the supporting body 30, as well as to an upper portion of the left side part 22 and the long leg 32 respectively. It thereby extends approximately the same distance downward, just as the supporting body 30 also extends upward. This also allows for stiffening the acute-angled triangle. The carrier arm 60 is preferably solidly connected, more specifically welded, to the frame 20 and to the supporting body 30.

The double seat bench viewed in FIG. 2 is an example for a multiple seat bench; in accordance with the invention, seat benches having any number of seats can be manufactured. It can be seen that the double seat back rest is substantially double the seat back shown in FIG. 1, except that no right side part is provided on the seat back that has been added. The frame 20 of the added left seat back now consists of a U-shaped structure that is open toward the right seat back. Accordingly, a connecting piece 50 may also lack. The left seat back has no reception 52 and no mountings arm 54; the described triangular structure with the supporting body 30 is used in lieu of these parts and also of the missing right side part 24.

The left outer side of the added seat back is again configured like the seat back shown in FIG. 1. The right seat back corresponds to the one shown in FIG. 1.

What is claimed is:

1. A seat back of a motor vehicle seat comprising an integrated seat belt, said seat back comprising
a) a frame having two side parts, an upper base connecting said side parts and a first upper corner,
b) an upper belt point in proximity to said first upper corner,
c) an L-shaped supporting body, said supporting body having a long leg connected to said frame in proximity to said first upper corner, of a length substantially equalling the length of the neighbouring side part and extending at an acute angle with respect to said neighbouring side part, and a short leg that is connected to said upper base, and
d) a lower carrier piece that connects a lower end of said long leg to said neighbouring side part so that said neighbouring side part, said long leg and said carrier piece form an acute-angled triangle.

2. The seat back of claim 1, wherein said L-shaped supporting body is located before said neighbouring side part when viewed in the x direction.

3. The seat back of claim 2, wherein a carrier arm projects upward at said first upper corner and forms said upper belt point.

4. The seat back of claim 3, wherein said carrier arm is connected to said neighbouring side leg and to said long leg, said connection respectively occurring in an upper portion of said neighbouring side part and of said long leg.

5. The seat back of claim 1, wherein said triangle is formed from said long leg, said neighbouring side part and said lower carrier piece is substantially lying in the x-z plane.

6. The seat back of claim 1, wherein said lower carrier piece is connected to said long leg and said neighbouring side part over at least 20 mm.

7. The seat back of claim 1, including cross beams which are interposed between said neighbouring side part and said long leg.

8. The seat back of claim 1, wherein said short leg extends parallel to said upper base.

9. The seat back of claim 1, wherein said short leg extends parallel to the y axis.

10. The seat back of claim 1, wherein said frame is a bent tube frame.

11. The seat back of claim 1, wherein said supporting body is an L-shaped bent piece of tube, having a tube diameter of at least 18 mm, and that the wall thickness is at least 1.2 mm.

12. The seat back of claim 1, wherein said frame is a tube profile bent into a U-shape and comprises a lower base for connecting said two side parts together.

13. The seat back of claim 1, wherein the length of said short leg is 15 to 30% of the length of said upper base.

14. The seat back of claim 1, wherein said short leg has a curved region and said long leg merges into said curved region, and that said neighbouring side part merges into said upper base in a curvature and that these two curvatures have at least one of the same course and the same radius.

15. The seat back of claim 1, wherein said lower carrier piece is connected to said long leg and also to said neighbouring side part over 40 mm.

16. The seat back of claim 7, wherein said cross beams take the form of a zigzag shaped bracing.

17. The seat back of claim 1, wherein said supporting body is an L-shaped bent piece of tube having a tube diameter of at least 22 mm, and that the wall thickness is at least 1.8 mm.

18. The seat back of claim 1, wherein the length of said short leg is about 20% of the length of said upper base.
